(19) United States
(12) Patent Application Publication
(10) Pub. No.: US 2017/0144170 A1
(43) Pub. Date: May 25, 2017

(54) UNDERFROTH WASHING IN FROTH FLOTATION

(71) Applicants: Glenn S. Dobby, Toronto (CA); Glenn A. Kosick, Toronto (CA)

(72) Inventors: Glenn S. Dobby, Toronto (CA); Glenn A. Kosick, Toronto (CA)

(21) Appl. No.: 15/360,427

(22) Filed: Nov. 23, 2016

Related U.S. Application Data
(60) Provisional application No. 62/258,711, filed on Nov. 23, 2015.

(51) Int. Cl. B03D 1/14; C02F 1/24; B03D 1/02; B01D 21/00

(52) U.S. Cl. CPC B03D 1/1406; B01D 21/0084; C02F 1/24; B03D 1/02; C02F 2103/10

(57) ABSTRACT

The invention relates to a method and apparatus for minimizing froth drop back in a flotation cell undergoing froth flotation. The flotation cell has a slurry phase, a froth phase and a froth/slurry interface. Water is injected into the flotation cell at a position beneath the froth/slurry interface.

### FIELD

This invention relates to the field of froth flotation.

### BACKGROUND

Froth flotation has been used for more than a century in the mining industry to separate mineral particles from waste particles in slurries. Other resource industries use froth flotation to separate such things as oil from sand or waste, and ink and/or waste from pulp in the pulp and paper industry.

In the mining industry, after rock is mined, it is typically crushed to the consistency of mud and then diluted with water to form a slurry, typically having approximately 30% solids by weight. Once the ore is in slurry form, it can be subjected to froth flotation to separate the desired mineral from the waste or sand particles.

The process of froth flotation commonly involves several steps. The first step typically involves adding chemicals, called surfactants, to the slurry to reduce the surface tension of the water in the slurry and, in the case of minerals, to coat the mineral surface with a molecular layer of surfactant, thus causing the mineral to become hydrophobic. Next, gas bubbles (commonly air) are injected into the slurry, which is contained in a vessel or flotation cell. A form of energy is then applied to force the mineral particles onto the gas bubbles, such that when the gas bubbles float to the surface they carry the mineral particles with them. Mechanical agitation and the separation Finally, the mineral laden gas bubbles are removed from the surface of the vessel for subsequent processing by more flotation units or by other process operations.

Flotation circuits generally comprise a rougher circuit, which recovers most of the valuable mineral but at low purity or grade, and a cleaner circuit, which can consist of multiple stages of ganged cells with recirculating streams. A cleaner flotation circuit generally treats smaller process flows than a rougher circuit as it upgrades the froth product from the rougher circuits.

There are different methods commonly used to apply energy to force mineral particles onto the gas bubbles. One method involves utilizing a tall vessel (generally 10 to 15 meters) where the slurry is introduced at or near the top of the vessel and air is introduced at or near the bottom. Air is commonly introduced using sparging techniques, or through pumping tailings (slurry depleted to various degrees in terms if valued mineral) from the bottom of the cell and back into the bottom of the cell through a restriction in the line (such as a fixed spiral or orifice) to which air is added. The falling particles in the slurry tend to collide with the rising bubbles and make contact. The bubbles form a froth at the top of the vessel and overflow into a launder for collection. This particular process is typically referred to as column flotation and the vessel is often referred to as a column flotation cell.

A second method of adhering mineral particles onto gas bubbles involves contacting feed slurry (as opposed to tailings slurry discussed above) and air through a pressure drop in a pipe, and then discharging the slurry-air mixture into a vessel for gas slurry disengagement, generally referred to as stage flotation. The resulting froth is then removed from the top of the vessel, similar to the process used in column flotation. Examples of this type of flotation vessel are known as the Contact Cell and the Jameson Cell.

A third, and probably most common, method to achieve particle/bubble contact utilizes an agitator in an open topped vessel to stir the slurry rigorously, while either injecting or aspirating gas down the shaft of the agitator, thereby forcing the particles onto the gas bubbles. The gas bubbles then float to the top of the vessel and are removed in a similar fashion to that of column flotation. Such mechanically agitated flotation vessels are referred to in the industry as mechanical cells or conventional cells. These cells can be rectangular or circular in shape. The circular mechanical cells (or tanks) are referred to as tank cells and are the more popular type of mechanically agitated cell currently in use.

Mechanical flotation cells are the most commonly used flotation machines in the mining and oil sands industry. These vessels typically have an impeller sitting within a nest of baffles, referred to in the industry as a stator. The impeller agitates the slurry to keep the slurry in suspension, to generate gas bubbles, and to force particles onto the gas bubbles. Similar to the other described methods, the mineral laden gas bubbles then float to the top of the vessel where they form a froth. The froth is subsequently removed and directed to another stage of flotation, or other processing operation. In each case, the mechanical agitation and the separation of the gas bubbles from the slurry take place in the same vessel. The vessels are usually combined in series (commonly in groups of two to eight vessels) to form what is referred to as a bank of flotation cells. Depending on the size of the mining operation, many times, there are multiple banks of cells operating in parallel in the mineral processing plant. Mechanically agitated flotation cells are widely used because of their ability to generally create high bubble shear compared to other types of flotation cells. Mechanically agitated flotation cells tend to be used almost exclusively over other flotation cells in the primary (or rougher) section of a flotation circuit.

In all three general types of flotation cells described above, there is a froth/slurry interface at or near the top of the cells. When a rising mineral laden bubble reaches the interface, its rise velocity slows dramatically, often resulting in a shock that may dislodge mineral particles from the bubble. This phenomenon is referred to as froth drop back. In the case of flotation cells used today, the dislodged particles fall back into the slurry and must re-adhere to a gas bubble within that vessel, or they will report to a subsequent collection stage for recovery. In large flotation cells with a low mass flux of minerals to the froth, the amount of minerals dropping back into the froth can be as high as 80-90%. As a result, mathematical modeling of the froth flotation process commonly applies a froth recovery factor. Laboratory measurements of froth drop back have been performed, one of which was reported by Falutsu, M., Dobby, G.S., 1989, Direct measurement of froth dropback and collection zone recovery in a laboratory flotation column, Minerals Engineering 2 (3), 377-386.

Conventional mechanically agitated flotation cells can require a significant amount of energy and flotation cell volume to keep the slurry in suspension, and to recollect mineral particles that drop back from the froth/slurry interface into the slurry within the agitated vessel. Since there are usually a number of flotation vessels working together as a flotation circuit (several cells in series), particles that are rejected from the slurry in the latter vessels in the series do not have the full residence time of the complete series for recollection. As well, it is generally accepted in the industry that particle drop back in the latter vessels of the series is typically higher than in the earlier vessels in the series because there are less hydrophobic solids being recovered, which often results in lower froth stability.

In some instances, flotation cells, such as column flotation cells, apply wash water above the froth, using drip pans or perforated pipe manifolds, to displace water in the feed slurry, which carries gangue or undesired particles into the froth by entrainment. Entrainment is the carrying of undesired particles into the froth by means of the rise velocity of the water in the slurry (i.e. no attachment to bubbles occurs). Typically, these particles are on the finer end of the particle size distribution of the feed. Washing the froth from above will commonly result in increased concentrate grade, through displacing entrained particles. However, a downside is that froth drop back is often enhanced due to bubble breakage. Circuit residence time is also commonly reduced. Both drop back and reduced circuit residence time tend to cause lower recovery of valuable minerals. Accordingly, wash water as currently applied in the industry typically increases concentrate grade, but it also tends to decreases recovery.

### SUMMARY

In one aspect of the invention a method for minimizing froth drop back in a flotation cell undergoing froth flotation is provided. The flotation cell has a slurry phase, a froth phase and a froth/slurry interface, where the method comprises injecting water into the flotation cell at a position beneath the froth/slurry interface.

The invention also provides an apparatus to aid in the minimization of froth drop back in a flotation cell undergoing froth flotation. The flotation cell contains a reagentized slurry to which air has been added to create a froth, where the transition between the slurry and the froth forms a froth/slurry interface. The apparatus comprises a plurality of pipes extending into the flotation cell and terminating in the slurry below the froth/slurry interface, where the pipes deliver water to the slurry beneath the froth/slurry interface.

The invention further provides a plurality of flotation cells for performing successive froth flotation on a reagentized slurry, where each flotation cell includes a particle collection unit and a bubble disengagement unit. The flotation cells also include a slurry feed inlet and a tailings outlet. The flotation cells are positioned adjacent to one another, where adjacent flotation cells are fluidly connected in series such that the tailings outlet of an upstream flotation cell is in fluid communication with the slurry feed inlet of an immediately adjacent downstream flotation cell. The tailings outlets and the slurry feed inputs are oriented tangential to their respective flotation cells, permitting the particle collection units and the bubble disengagement units of adjacent flotation cells to be physically positioned close together in a manner that aids in minimizing space between the particle collection and bubble disengagement units. This tends to reduce the overall area required to house the flotation cells and to help reduce bubble coalescence within piping joining adjacent flotation cells.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a schematic drawing of an embodiment of a stage flotation reactor in accordance with the invention.

FIG. 2 is a schematic drawing of an under froth washing arrangement in association with the stage flotation reactor of FIG. 1.

FIG. 3 is a schematic drawing of the under froth washing arrangement of FIG. 1 with anti-turbulence plates.

FIG. 4 is a top plan view of a possible partition arrangement for use in association with the under froth washing arrangement of FIG. 1.

FIG. 5 is a schematic drawing of the top and side of a stage flotation reactor in accordance with the invention demonstrating a tapered froth recovery unit and launder designed to assist in the minimization of transport distance of the froth.

FIG. 6 is a schematic drawing of three stage flotation reactors of FIG. 1 as they may be connected in series, showing step height.

FIG. 7 is a schematic top plan view of FIG. 6.

### DESCRIPTION

The present invention may be embodied in a number of different forms. The specification and drawings that follow describe and disclose some of the specific forms of the invention.

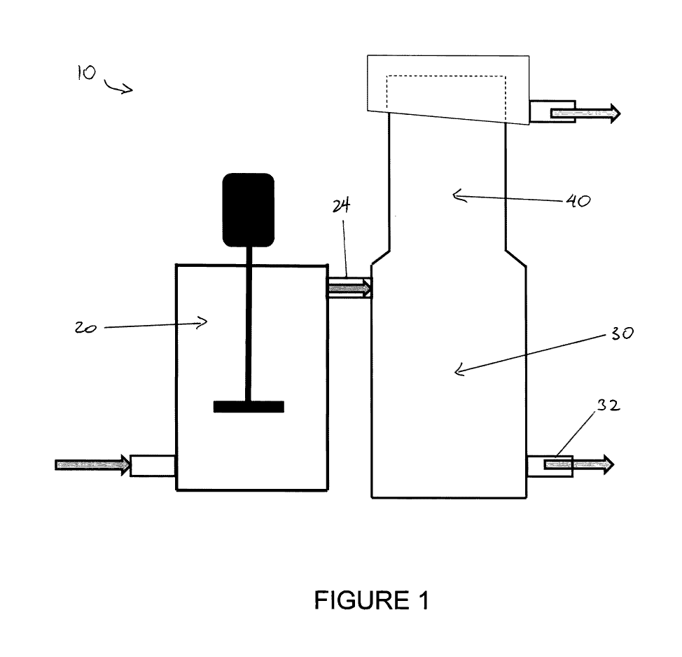

With reference to FIGS. 1-3, there is shown schematic drawings of a stage flotation reactor 10 in accordance with one embodiment of the invention. As depicted in FIG. 1, the stage flotation reactor consists of three compartments. The first compartment is a particle collection unit (PCU) 20. The second compartment is a bubble disengagement unit (BDU) 30. The third compartment is a froth recovery unit (FRU) 40. It will be appreciated by those skilled in the art that the process nature, configuration and location of each compartment may vary while remaining within the scope of the invention.

In the depicted embodiment, PCU 20 includes a slurry feed input 22, a gas input (not shown), and an agitator 26. Reagentized slurry (i.e. slurry which has been mixed with surfactant chemicals such that minerals in the slurry become coated with surfactant and thereby rendering the mineral hydrophobic) is fed near the bottom of PCU 20 via slurry feed input 22. Gas (air) is fed directly into PCU 20 or fed into slurry feed input 22 via the gas input. The top of PCU 20 is sealed. The reagentized slurry and gas are agitated by an impeller 28 turning at relatively high speeds. The agitation causes the hydrophobic minerals to adhere to gas bubbles in PCU 20. The slurry along with the gas bubbles, now carrying collected mineral particles, exists together near the top of the PCU.

As shown in the depicted embodiment, the slurry and gas bubbles are transferred via a conduit 24 to the second compartment, BDU 30.

In BDU 30, the gas bubbles carrying the hydrophobic minerals are allowed to float upwards. The remaining slurry, without gas bubbles, is eventually discharged from BDU 30 via a tailings output 32. The BDU allows sufficient time for the slurry to exit the bottom of the reactor without carrying gas bubbles.

The gas bubbles that rise upwardly in the BDU, typically along with a small amount of entrained slurry, enter the third compartment of stage flotation reactor 10, FRU 40.

After the gas bubbles and slurry enter FRU 40, a gas/slurry interface 42 is allowed to form (by maintaining control of the discharge rate of BDU 30). A froth 43 is created above gas/slurry interface 42. The froth overflows a froth discharge lip 38 of FRU 40 to form the froth product (not shown). Since there is no collection process in BDU 30 to recover minerals particles that have dropped off the gas bubbles, the dropped minerals will exit BDU 30 with the main tailings from tailings output 32 to the next flotation stage or the next unit of operation. The mineral particles from such froth drop back will potentially be lost, thereby potentially lowering the overall combined PCU/BDU mineral recovery.

The diameter of FRU 40 may vary depending on the ore body that it is to be processed in order to help ensure that froth 43 is properly supported and discharged while reducing froth drop back (which often occurs in other flotation cells).

At times, froth 43 may be washed from above, or within the froth, generally resulting in increased mineral concentrate grade (by displacing entrained particles). However, as discussed above, such washing tends to increase froth drop back.

Multiple stage flotation reactors are commonly ganged together in series to form a circuit. Slurry will generally flow from cell to cell by gravity. In many instances, five to seven stage flotation reactors will be employed as a circuit, where the first BDU tailings are fed to the second PCU feed inlet, the second BDU tailings are fed to the third PCU feed inlet etc. The resulting froth products are collected, and may or may not subsequently be combined for further processing.

Factors that can affect the desirability of the above generally described processes and its costs include (i) step height (vertical distance) between cells to overcome pressure drops in the system, (ii) energy consumed, (iii) footprint required for installing the cells (which affects excavation requirements, concrete, support steel, services, etc.), (iv) froth drop back, and (v) ability to wash the final product.

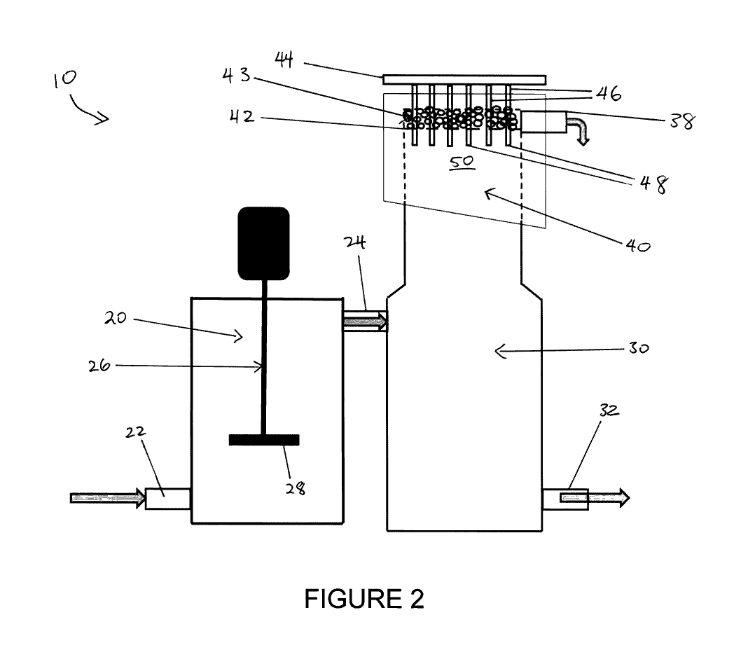

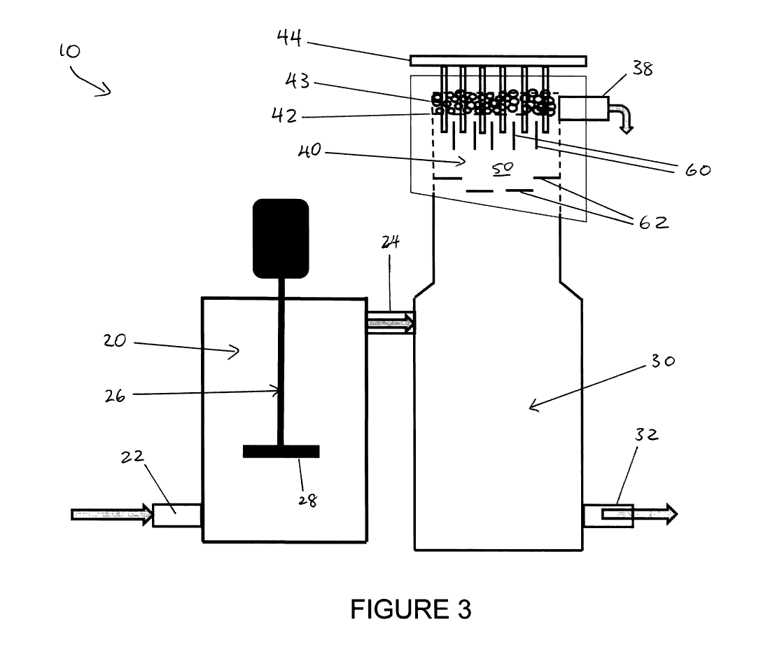

Unique to the stage flotation reactor of the present invention is the utilization of what the applicant has termed “underfroth washing” (see FIGS. 2 and 3 in particular). In underfroth washing, wash water is injected under froth/slurry interface 42 in FRU 40 and into the slurry itself. The area in the slurry where the water is injected is referred to as wash zone 50. Wash water is injected by means of a piping manifold 44 at the top of FRU 40 that distributes water through individual pipes 46. Pipes 46 extend through froth 43 to water injection points 48 below froth/slurry interface 42 into the slurry.

The wash water dilutes the feed slurry below froth/slurry interface 42, displacing water in the feed slurry, which may be caught by the rising gas bubbles before the gas bubbles enter froth 43. Since dilution occurs in the slurry just below froth/slurry interface 42, it has been found that, surprisingly, the incidence of bubble breakage and froth drop back on account of the wash water addition tends to be minimized. Further, it has been found that the underfroth washing generally does not disrupt the froth phase.

Underfroth washing may also be applied to the rougher stage of flotation, whereas other methods of froth washing (due to the drop back) typically can only be economically applied to the final cleaning stage of flotation.

The depicted embodiment of the invention provides for injecting water under or beneath froth/slurry interface 42 and into the slurry as a means of displacing water already residing in the slurry. Wash water typically would not be applied above or within froth 43 in stage flotation reactor 10 as there is no collection occurring in BDU 30. If froth drop back occurs due to bubble breakage, the valued minerals dislodged into BDU 30 as a result of drop back tend not to be recovered. Additionally, the froth density and bubble formation in a stage flotation reactor is usually higher and “tighter”, than in the case of other flotation cells. Therefore, over froth washing in stage flotation reactors tends to be less effective because the wash water has difficulty penetrating the froth.

The surface area of the stage flotation reactor according to the present invention, relative to the tonnage of solids recovered in froth 43, is typically much smaller than other flotation cells. As such, less water from the feed is entrained within froth 43. In this way, the wash water for underfroth washing in stage flotation reactors may not need to be as “efficient” as over froth washing in other cells (in terms of water consumption required per cubic meter of feed slurry water reporting to the froth). It has been determined that the overall wash water consumption rate for underfroth washing in a stage flotation reactor is similar to that of over froth washing in other flotation cells (since the amount of feed water to be displaced in a stage flotation reactor is less than that in other flotation cells).

The described underfroth washing in a stage flotation reactor tends to increase mineral concentrate grade without sacrificing recovery. This is distinguished from conventional froth washing systems that can increase concentrate grade, but usually at the expense of recovery. Further, underfroth washing generally removes the need for a particle drop back output within BDU 30 and/or FRU 40.

Having knowledge of the invention herein, one of ordinary skill in the art will understand that underfroth washing may be employed in a wide variety of different manners using a variety of different piping or structures, other than that depicted in the attached Figures. Many physical structures could effectively deliver water evenly and with low pressure beneath the froth/slurry interface. Rather than the depicted piping manifold 44 at the top of FRU 40 (depicted in FIG. 2) the wash water delivery pipes could equally extend through the side and/or bottom walls of BDU 30 and/or FRU 40. The number and size of pipes delivering water can and will likely vary depending on the particular application and the mineral to be recovered. In each case, it is generally preferable to apply a gentle, low pressure, injection of wash water.

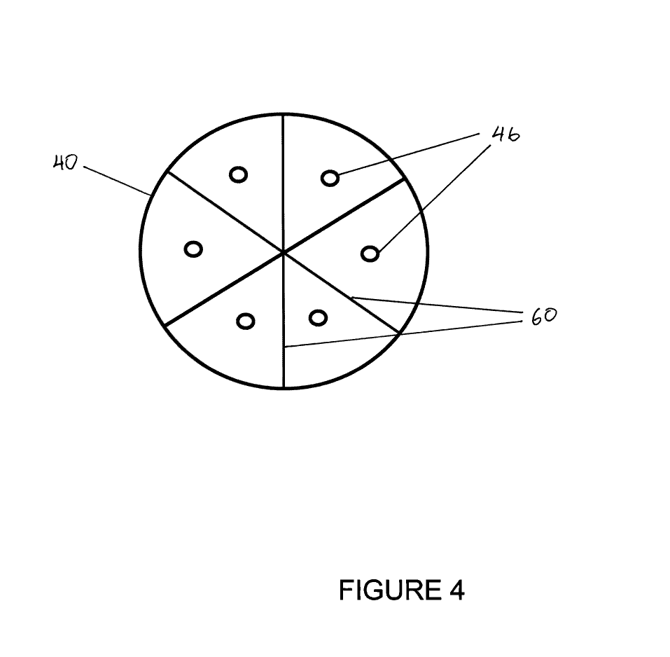

In another embodiment of the invention (shown in FIGS. 3 and 4), partitions 60 may be inserted between pipes 46 or water injection points 48 to help contain the wash water within particular segments of the slurry. Such partitions may assist in reducing turbulence and may help to ensure that each segment gets effectively washed.

Anti-turbulence plates 62 can optionally be installed below water injection points 48. Anti-turbulence plates 62 may further reduce turbulence in wash zone 50, which may help reduce froth drop back.

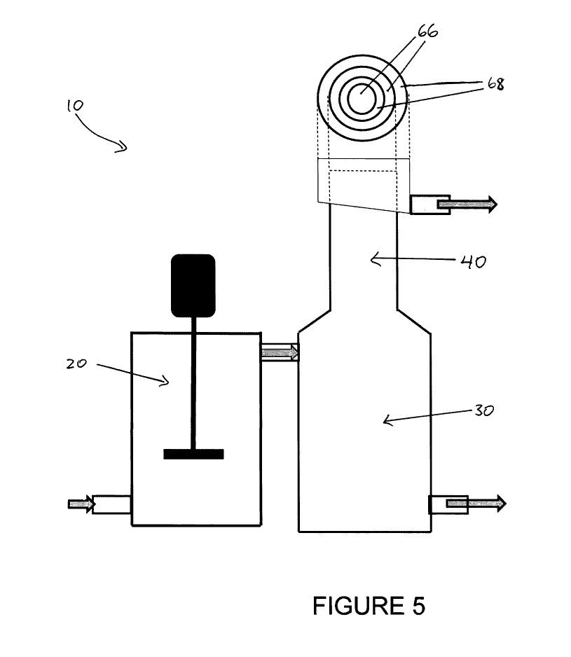

It has been determined that customizing the active surface area at the top of FRU 40 to tightly constrain froth 43 may also help to reduce froth drop back, potentially to a point where the effect of drop back on the overall process is inconsequential. In prior FRU units, throttling plates were employed. Throttling plates were previously thought to be required to help ensure that the particles from the froth drop back were recovered. Through embodiments of the current method, throttling plates may be eliminated by changing active surface area 66. To aid in eliminate throttling plates, active surface area 66 of FRU 40 is sized to ensure that the carrying capacity of the active surface area (defined as tph/m2) is kept high enough so that froth 43 is sufficiently “squeezed” to maintain bubble support (see FIG. 5). In addition to the squeezing of froth 43, a launder 68 may be designed and used to assist in the minimization of transport distance of froth 43.

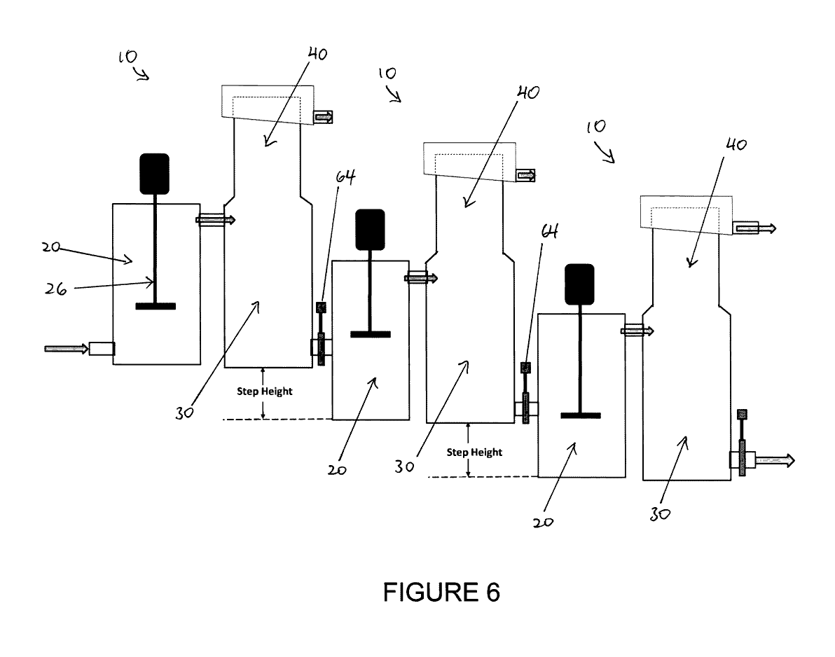

In accordance with a further embodiment of the invention, slurry is tangentially injected into PCU 20 through slurry feed input 22 in which is mounted a modified knifegate valve 64 for slurry level control. Both the tangential feed and modified knifegate valve 64 help to shorten the transport distance between the BDU and the PCU, which can improve the effectiveness of the stage flotation reactor. FIG. 6 shows a schematic for a circuit of three stage flotation reactors.

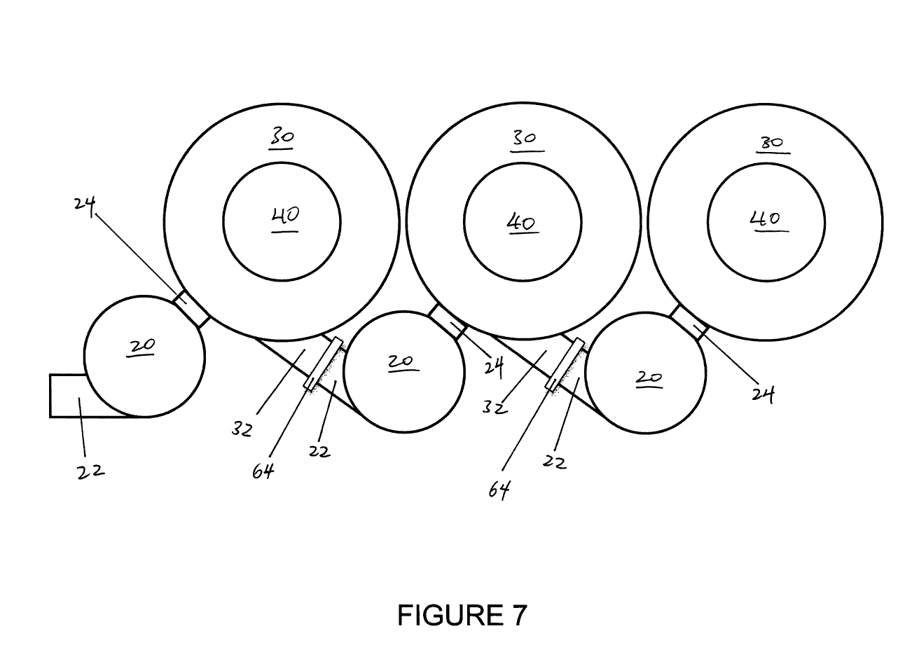

It was previously believed that a tangential inlet into a PCU would be inconsequential to the operation of the stage flotation reactor. However, it has been found, surprisingly, that injecting feed slurry tangentially (see FIG. 7) may have certain advantages.

First, tangential injection of feed slurry into PCU 20 helps to reduce back pressure on slurry feed inlet 22. The pumping action and vortices created by impeller 28 tends to create a pulsating back pressure on slurry feed inlet 22. This pulsating back pressure requires a greater step height between cells in order to overcome the additional pressure drop, which is an undesired result. By changing to a tangential feed, the pulsating back pressure may be reduced.

Secondly, it has been found that injecting feed tangentially tends to impart circular momentum into the slurry, thereby helping to reduce the energy required to put the slurry into motion.

Thirdly, the same circular momentum of the slurry further helps to reduce pressure drop within stage flotation reactor 10. The lower pressure drop from the tangential input helps to allow the step height to be reduced (see generally FIG. 6). Reducing vertical height between flotation cells is advantageous because higher step heights between multiple stage flotation reactors tend to require more infrastructure to support and/or house. Further, higher energy costs are also likely to result from higher pumping requirements.

A fourth advantage of tangential feed injection is that it allows PCU 20 and BDU 30 vessels to be positioned closer together, as shown in FIG. 7, which may reduce their combined footprint and related infrastructure requirements. Placing the PCU and the BDU close together also tends to reduce bubble coalescence.

In the embodiment of the invention where modified knifegate valve 64 is installed between PCU 20 and BDU 30, the valve serves to center the slurry flow through the center of the valve and uses a secondary sliding plate to control the flow volume through the valve's orifice. It has been found that use of a tangential feed inlet provides enough room to enable the use of modified knifegate valve 64, while maintaining adjacent flotation cells in close proximity to one another, thereby helping to minimize footprint.

By keeping the feed side of the BDU vessel close to the previous BDU vessel, the transfer pipe on the opposite side of the BDU can be shorter as well, because the subsequent BDU can be moved closer to the PCU. Essentially, the tangential feed port and knifegate valve 64 allow the PCU to tuck into the void created by two adjacent BDU's. This feature is not only advantageous from a footprint reduction standpoint (which can result in capital reduction), but it is also advantageous from a process perspective. By keeping the vessels close together, bubble coalescence is reduced within the piping. When bubble coalescence occurs, bubble breakage typically results and the desired particles that were attached to the bubbles become lost in the tailings. If the flow rate were to be increased to overcome coalescence, the pressure drop will tend to increase, driving up the step height and causing associated difficulties and increased energy consumption. The use of a tangential feed port and knifegate valve 64 helps to permit bubble coalescence without increasing flow rates.

As seen in FIG. 6, the tangential feed enters PCU 20 at or near the bottom of the vessel. This tends to reduce back pressure pulsation and imparts a centrifugal momentum to the slurry at the bottom of PCU 20 and reduces the entrance pressure loss. The combined reduction in pressure loss contributes to a lowering of the subsequent step height required between cells. The circular motion continues in the center of the cell (enhanced by agitator 26) and partially carries that momentum to the top of PCU 20 where it exits the tank, either perpendicularly or tangentially from the wall of PCU 20 (tangentially being generally preferred). Through directing the tangential feed in the direction imparted to the slurry by agitator 26, the amount of energy absorbed through the entrance is minimized. This allows agitator 26 to use less energy to put the slurry into motion. Energy imparted by agitator 26 is then available for bubble shearing and particle collection.

Those skilled in the art will appreciate that increased rougher concentrate grade will tend to reduce the size of any downstream regrinding, as well as reduce the size of required pipes, pumps and downstream flotation equipment. Furthermore, increased rougher concentrate grade provides a higher grade feed to subsequent cleaning circuits, which makes it easier for the cleaning circuit to reach its metallurgical performance targets.

Moreover, it is known that conventional flotation cells in the industry operate impellers with tip speeds of approximately 5 m/s, or greater. Through utilization of the above described structure, it has been discovered that impeller tip speeds in PCU 20 of approximately 3.2 m/s to 4.8 m/s are achievable while remaining within acceptable overall process operating parameters. The ability to operate at these lower tip speeds for froth flotation in a production environment may help to lower energy requirements in froth flotation circuits.

The lower impeller tip speed may be achieved by constraining the diameter of PCU 20 to the point of maintaining enough upward velocity which, when combined with turbulence from impeller 26, tends to support the mineral particles (which can typically vary from 300 microns to less than 10 microns) while not compromising the edge residence time required across the impeller blade. Stage flotation reactor 10 of the present invention uniquely permits such impeller speeds to be achieved.

It is to be understood that what has been described are the preferred embodiments of the invention. The scope of the claims should not be limited by the preferred embodiments set forth above, but should be given the broadest interpretation consistent with the description as a whole.

### REFERENCES (The Contents of Which are Incorporated Herein by Reference)

WO 2011/094842; Dobby, G. S. and Kosick, G. A., 2011.
Falutsu, M., Dobby, G. S., 1989. Direct measurement of froth dropback and collection zone recovery in a laboratory flotation column.
Minerals Engineering 2 (3), 377-386.
Finch, J. A. and Dobby, G. S. “Column Flotation,” Pergamon Press, London, ISBN 0-08-040186-4.(1990).

1. A method for minimizing froth drop back in a flotation cell undergoing froth flotation, the flotation cell including a slurry phase, a froth phase and a froth/slurry interface, the method comprising injecting water into the flotation cell at a position beneath the froth/slurry interface.

2. The method as claimed in claim 1 wherein water is injected into the flotation cell through use of a piping manifold positioned above the flotation cell, said piping manifold having a plurality of pipes extending therefrom into the froth phase, said pipes delivering water to a position beneath the froth/slurry interface.

3. The method as claimed in claim 1 including locating partitions within the froth phase in the flotation cell, said partitions oriented generally parallel to the longitudinal axis of the flotation cell and compartmentalizing the froth phase, said partitions forming compartments extending from above the froth phase to beneath the froth/slurry interface, said water injected beneath the froth/slurry interface within each respective compartment.

4. The method as claimed in claim 3 including the positioning of anti-turbulence plates within the flotation cell at a position below the position where the water is injected, said anti-turbulence plates aiding in reducing turbulence in the slurry while said slurry is undergoing froth flotation.

5. The method as claimed in claim 4 wherein said pipes discharge water into the flotation cell parallel to the longitudinal axis of the flotation cell.

6. The method as claimed in claim 4 where said pipes discharge water into the flotation cell perpendicular to the longitudinal axis of the flotation cell.

7. The method as claimed in claim 4 wherein said pipes discharge water into the flotation cell at an inclined angle to the longitudinal axis of the flotation cell.

8. An apparatus to aid in the minimization of froth drop back in a flotation cell undergoing froth flotation, the flotation cell containing a reagentized slurry to which air has been added to create a froth, wherein the transition between the slurry and the froth forms a froth/slurry interface, the apparatus comprising a plurality of pipes extending into the flotation cell and terminating in the slurry below the froth/slurry interface, said pipes delivering water to the slurry beneath the froth/slurry interface.

9. The apparatus as claimed in claim 8 wherein said pipes are fluidly connected to a manifold, said manifold directing water to each of said pipes.

10. The apparatus as claimed in claim 9 wherein said manifold is positioned above the flotation cell and said pipes extend from said manifold into the flotation cell to a position beneath the froth/slurry interface.

11. The apparatus as claimed in claim 8 wherein said flotation cell further includes anti-turbulence plates positioned below the location where the water is injected, said anti-turbulence plates aiding in helping to reduce turbulence within the slurry.

12. The apparatus as claimed in claim 8 wherein the flotation cell includes a plurality of partitions positioned generally parallel to the longitudinal axis of the flotation cell, said partitions forming compartments extending from above the froth phase to beneath the froth/slurry interface when the flotation cell is undergoing froth flotation, said pipes injecting water beneath the froth/slurry interface within each compartment.

13. The apparatus as claimed in claim 8 wherein said flotation cell is a column flotation cell.

14. The apparatus as claimed in claim 8 wherein said flotation cell is a contact flotation cell.

15. The apparatus as claimed in claim 8 wherein said flotation cell is a tank flotation cell.

16. A plurality of flotation cells for performing successive froth flotation on a reagentized slurry, each flotation cell including a particle collection unit and a bubble disengagement unit, the flotation cells including a slurry feed inlet and a tailings outlet and positioned adjacent to one another with adjacent flotation cells fluidly connected in series such that the tailings outlet of an upstream flotation cell is in fluid communication with the slurry feed inlet of an immediately adjacent downstream flotation cell, said tailings outlets and said slurry feed inputs oriented tangential to their respective flotation cells thereby permitting the particle collection units and the bubble disengagement units of adjacent flotation cells to be physically positioned close together in a manner that aids in minimizing space between said particle collection and bubble disengagement units to reduce the overall area required to house said flotation cells and to help reduce bubble coalescence within piping joining adjacent flotation cells.

17. The device as claimed in claim 16 including a modified knifegate valve positioned between said adjoined particle collection units and bubble disengagement units, said modified knifegate valve serving to help center the flow of fluid through the center of the valve, to control the flow volume through the valve's orifice, and to minimize piping requirements so as to help maintain adjacent flotation vessels in close proximity to one another, thereby helping to minimize the overall space required to house said flotation cells and to reduce bubble coalescence within piping joining adjacent flotation cells.
